(19) United States
(12) Patent Application Publication
(10) Pub. No.: US 2025/0180857 A1
(43) Pub. Date: Jun. 5, 2025

(54) METHOD FOR CONTROLLING OPTICAL ELEMENT DRIVING MECHANISM

(71) Applicant: TDK TAIWAN CORP., Taoyuan City (TW)

(72) Inventors: Po-Xiang ZHUANG, Taoyuan City (TW); Kun-Shih LIN, Taoyuan City (TW); Yi-Ho CHEN, Taoyuan City (TW); Sin-Jhong SONG, Taoyuan City (TW); Ko-Lun CHAO, Taoyuan City (TW); Hsueh-Ju LU, Taoyuan City (TW); Shun-Chieh TANG, Taoyuan City (TW); Chao-Chang HU, Taoyuan City (TW)

(21) Appl. No.: 18/964,098

(22) Filed: Nov. 29, 2024

Related U.S. Application Data
(60) Provisional application No. 63/605,197, filed on Dec. 1, 2023.

(51) Int. Cl. G02B 7/08

(52) U.S. Cl. CPC G02B 7/08

(57) ABSTRACT

A method for controlling an optical element driving mechanism is provided. The method includes providing an optical element driving mechanism, wherein the optical element driving mechanism includes a movable portion, a fixed portion, and a driving component; and driving the movable portion to move in a first dimension relative to the fixed portion.

### CROSS REFERENCE TO RELATED APPLICATIONS

This application claims the benefit of U.S. Provisional Application No. 63/605,197, filed Dec. 1, 2023, the entirety of which is incorporated by reference herein.

### BACKGROUND OF THE INVENTION

### Field of the Invention

The present invention relates to a method for controlling an optical element driving mechanism, and in particular to a method for controlling an optical element driving mechanism with two integrated circuits.

### Description of the Related Art

With the advancement of technology, many electronic devices (e.g., smartphones) are nowadays equipped with photography and video recording functions. The demand for these electronic devices continues to grow, leading to designs that are slimmer and higher performing to provide users with more convenience and a diversity of options.

The aforementioned electronic devices with photography or video recording functions are typically equipped with an optical element driving mechanism, which drives the optical element (e.g., a lens) to move along the optical axis to achieve the desired optical effect. Light passes through the optical element to form an image on the image sensor. However, as mobile devices trend towards miniaturization and higher performance, enhancing the driving force of the driving components while maintaining their compact size has become a key focus of further development.

### BRIEF SUMMARY OF THE INVENTION

Embodiments of the present invention provide a method for controlling an optical element driving mechanism. The method includes providing an optical element driving mechanism, wherein the optical element driving mechanism includes a movable portion and a fixed portion; and driving the movable portion to move in a first dimension relative to the fixed portion.

According to some embodiments of the present disclosure, the optical element driving mechanism further includes a first driving portion and a second driving portion, and the method further includes: outputting a first driving signal to the first driving portion; and outputting a second driving signal to the second driving portion, wherein the first driving signal and the second driving signal are different from each other.

### BRIEF DESCRIPTION OF THE DRAWINGS

The embodiments of the present invention will be described in detail below with reference to the accompanying drawings. It should be noted that, consistent with standard practice in the industry, various features are not drawn to scale and are for illustrative purposes only. In fact, the dimensions of the elements may be arbitrarily enlarged or reduced in order to clearly convey the features of the invention.

FIG. 1 shows a perspective view of an optical element driving mechanism according to some embodiments of the present disclosure.

FIG. 2 shows an exploded view of the optical element driving mechanism according to some embodiments of the present disclosure.

FIG. 3 shows an exploded view of a base and a movable portion according to some embodiments of the present disclosure.

FIG. 4 shows a top view of the optical element driving mechanism according to some embodiments of the present disclosure, in which the upper cover is not shown for illustrative purposes.

FIG. 5 shows a perspective view of the base and a connection component that is at least partially embedded in the base, with the base shown in dashed lines for illustrative purposes, according to some embodiments of the present disclosure.

FIG. 6 shows a perspective view of the connection component according to some embodiments of the present disclosure.

FIG. 7 is a schematic circuit diagram of the optical element driving mechanism according to some embodiments of the present disclosure.

FIG. 8 is a flow chart of a first embodiment of a method for controlling the optical element driving mechanism.

FIG. 9 is a flow chart of a second embodiment of the method for controlling the optical element driving mechanism.

### DETAILED DESCRIPTION OF THE INVENTION

Unless otherwise defined, all terms used herein, including technical and scientific terms, have the same meaning as commonly understood by one of ordinary skill in the art. It is understood that these terms, such as those defined in commonly used dictionaries, should be interpreted as having a meaning that is consistent with their context in the relevant art and in the context of the present invention and should not be interpreted in an overly formal or idealized manner unless specifically defined herein.

Furthermore, ordinal numbers such as “first,” “second,” etc., used in the specification and claims to modify claim elements do not imply any specific priority or order of these elements, nor do they imply a specific sequence or order of manufacturing processes. The use of these ordinal numbers is solely for distinguishing elements with a certain designation from others with the same designation.

Additionally, in some embodiments of the present invention, the terms related to joining and connecting, such as “connected” and “interconnected,” unless otherwise defined, can refer to two structures that are either in direct contact or not in direct contact, where other structures may be positioned between the two. These terms may also include cases where both structures are movable or where both structures are fixed.

In the description of this specification, the use of reference terms such as “an embodiment,” “some embodiments,” and “example” means that the specific features, structures, materials, or characteristics described in connection with that embodiment or example are included in at least one embodiment or example of the invention. The schematic expressions of these terms do not necessarily refer to the same embodiment or example. Moreover, the specific features, structures, materials, or characteristics described may be combined in any suitable manner in one or more embodiments or examples. Additionally, one of ordinary skill in the art may combine or integrate the various embodiments or examples described in this specification.

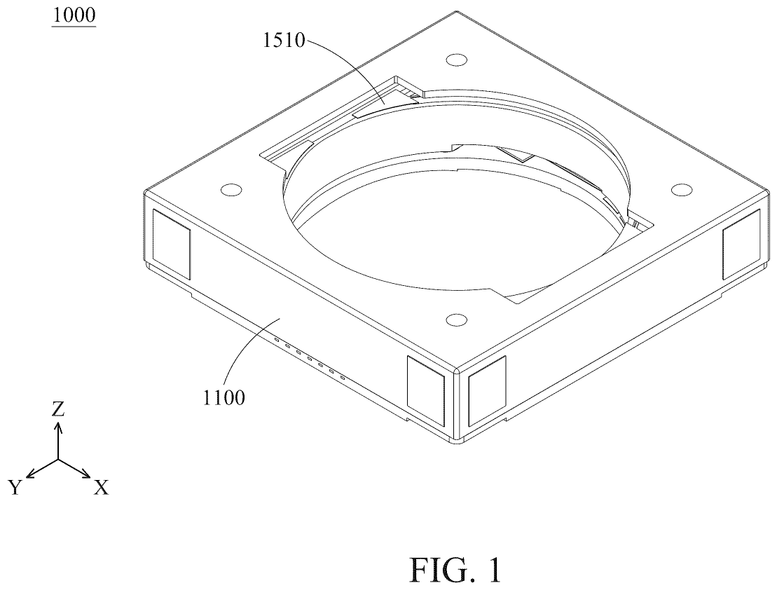

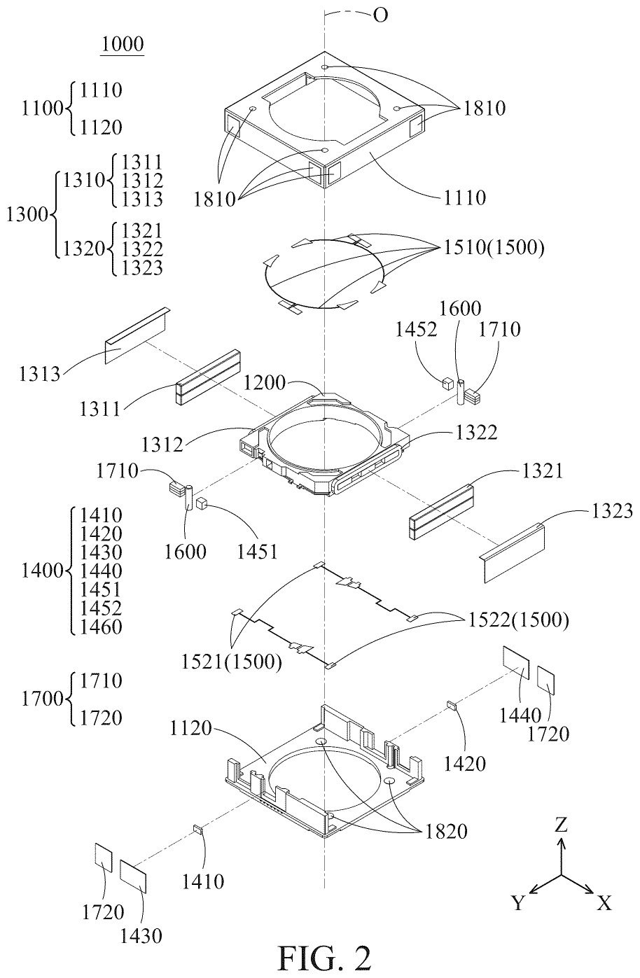

FIG. 1 shows a perspective view of an optical element driving mechanism 1000 according to some embodiments of the present disclosure. FIG. 2 shows an exploded view of the optical element driving mechanism 1000 according to some embodiments of the present disclosure. The overall structure of the optical element driving mechanism 1000 is described in detail below. Please refer to FIG. 1 and FIG. 2.

According to some embodiments of the present disclosure, the optical element driving mechanism 1000 includes a fixed portion 1100, a movable portion 1200, a driving component 1300, a control component 1400, an elastic component 1500, a pair of guide elements 1600, a pair of magnetic components 1700 and a plurality of buffer elements 1810, 1820.

According to some embodiments of the present disclosure, the fixed portion 1100 includes an upper cover 1110 and a base 1120. The upper cover 1110 is fixedly connected to the base 1120 to form a space for accommodating other elements of the optical component driving mechanism 1000.

According to some embodiments of the present disclosure, the movable portion 1200 is a holder connected to an optical element (not shown). The aforementioned optical element has an optical axis O, and the optical axis O is approximately parallel to the Z-axis. The movable portion 1200 is movable relative to the fixed portion 1100. The driving component 1300 is configured to drive the movable portion 1200 to move relative to the fixed portion 1100 in a first dimension. The first dimension movement refers to movement along the optical axis O.

According to some embodiments of the present disclosure, the driving component 1300 includes a first driving portion 1310 and a second driving portion 1320 to provide the movable portion 1200 with greater driving force. The first driving portion 1310 and the second driving portion 1320 are disposed on opposite sides of the optical element driving mechanism 1000. The first driving portion 1310 and the second driving portion 1320 are electrically independent of each other to drive the movable portion 1200 to move relative to the fixed portion 1100 in the first dimension.

According to some embodiments of the present disclosure, the first driving portion 1310 includes a driving magnetic element 1311, a driving coil 1312 and a magnetically permeable element 1313. The second driving portion 1320 includes a driving magnetic element 1321, a driving coil 1322 and a magnetically permeable element 1323.

According to some embodiments of the present disclosure, the driving magnetic elements 1311 and 1321 and the magnetically permeable elements 1313 and 1323 are provided on the upper cover 1110 of the fixed portion 1100. The driving coils 1312 and 1322 are provided on the movable portion 1200.

In this way, when a driving signal (e.g., a current applied by an external power source) is applied to the driving components 1300, electromagnetic induction forces are generated between the driving magnetic elements 1311, 1321 and the driving coils 1312, 1322, respectively, causing the movable portion 1200 to move relative to the fixed portion 1100, thereby achieving the desired optical effect. Furthermore, the magnetically permeable elements 1313, 1323 are configured to focus the magnetic force of the first driving portion 1310 and the second driving portion 1320, respectively, to achieve better driving performance.

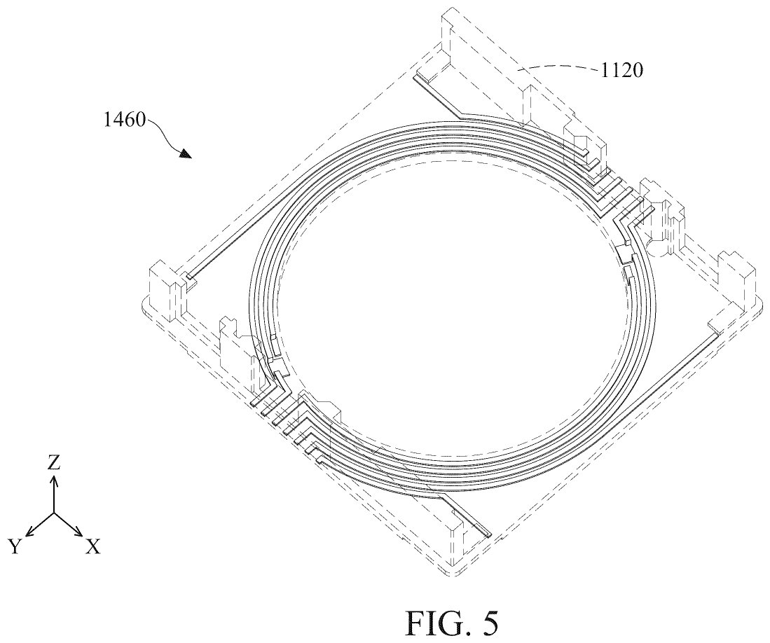

According to some embodiments of the present disclosure, the control component 1400 includes a first integrated circuit 1410, a second integrated circuit 1420, a first circuit member 1430, a second circuit member 1440, two sensing magnets 1451, 1452, and a connection component 1460 (FIG. 5).

According to some embodiments of the present disclosure, the first integrated circuit 1410 and the second integrated circuit 1420 may each be an all-in-one integrated circuit (All-in-one IC) that packages a sensing integrated circuit and a control integrated circuit within the same package. In other words, the first integrated circuit 1410 and the second integrated circuit 1420 may have both sensing and control functions as needed.

According to some embodiments of the present disclosure, the first integrated circuit 1410 is disposed on the first circuit member 1430. The second integrated circuit 1420 is disposed on the second circuit member 1440. The first integrated circuit 1410 corresponds to the sensing magnet 1451. The second integrated circuit 1420 corresponds to the sensing magnet 1452.

In detail, the first integrated circuit 1410 may sense changes in the magnetic field of the sensing magnet 1451, and the second integrated circuit 1420 may sense changes in the magnetic field of the sensing magnet 1452, and determine the position of the first movable portion 1200 relative to the fixed position 1100.

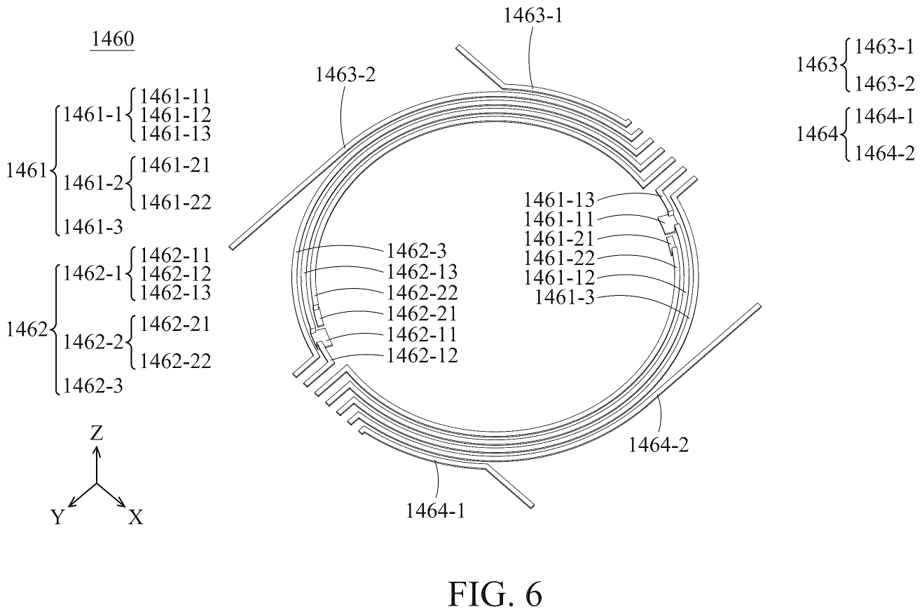

According to some embodiments of the present disclosure, the connection component 1460 (FIG. 5) are terminals embedded in the base 1120. The connection component 1460 is electrically connected to the driving coils 1312, 1322, the first circuit member 1430 and the second circuit member 1440. The details are explained in detail with reference to FIG. 5 and FIG. 6.

According to some embodiments of the present disclosure, the elastic component 1500 includes four first elastic elements 1510 and two sets of second elastic elements 1521 and 1522. The first elastic element 1510 is disposed on an end of the movable portion 1200 that is closer to the upper cover 1110. Opposite ends of the second elastic elements 1521 and 1522 are respectively provided on the base 1120 and the movable portion 1200.

According to some embodiments of the present disclosure, an optical module, e.g., aperture module, may be disposed on the optical element driving mechanism 1000, and the aforementioned optical module (not shown) may be electrically connected to the first elastic element 1510. The second elastic element 1521 is electrically connected to the driving coil 1312 of the first driving portion 1310, and the second elastic element 1522 is electrically connected to the driving coil 1322 of the second driving portion 1320.

According to some embodiments of the present disclosure, the guide elements 1600 are guide rods that guides the movable portion 1200 to move along the optical axis O relative to the fixed portion 1100. The guide elements 1600 are each provided between the fixed portion 1100 and the movable portion 1200.

According to some embodiments of the present disclosure, the pair of magnetic components 1700 each include a magnetic element 1710 and a magnetic plate 1720. The magnetic element 1710 is disposed on the movable portion 1200. The magnetic plate 1720 is disposed on the base 1120. The guiding elements 1600 may include a low magnetic permeability metal material to avoid interference with the magnetic attraction of the magnetic components 1700, while also preventing interference with the sensing signals of the first integrated circuit 1410 and the second integrated circuit 1420.

In this way, the magnetic attraction between the magnetic element 1710 and the magnetic plate 1720 allows the movable portion 1200 to rest against the two guiding elements 1600, ensuring smoother movement of the movable portion 1200 relative to the fixed portion 1100 and reducing the likelihood of shaking, overturning, or similar issues. This enhances the precision of the autofocus operation.

According to some embodiments of the present disclosure, the buffer elements 1810 and 1820 may be made of materials such as silicone. The buffer elements 1810 are disposed on the surface of the upper cover 1110 to buffer the impact caused by the collision between the optical element driving mechanism 1000 and an optical mechanism (not shown) housing the optical element driving mechanism 1000 and absorb the abnormal noise caused by the impact.

According to some embodiments of the present disclosure, the buffer elements 1820 are provided on the base 1120 to buffer the impact force generated when the movable portion 1200 moves to its limit position and collides with the base 1120, as well as to absorb abnormal noise caused by the impact.

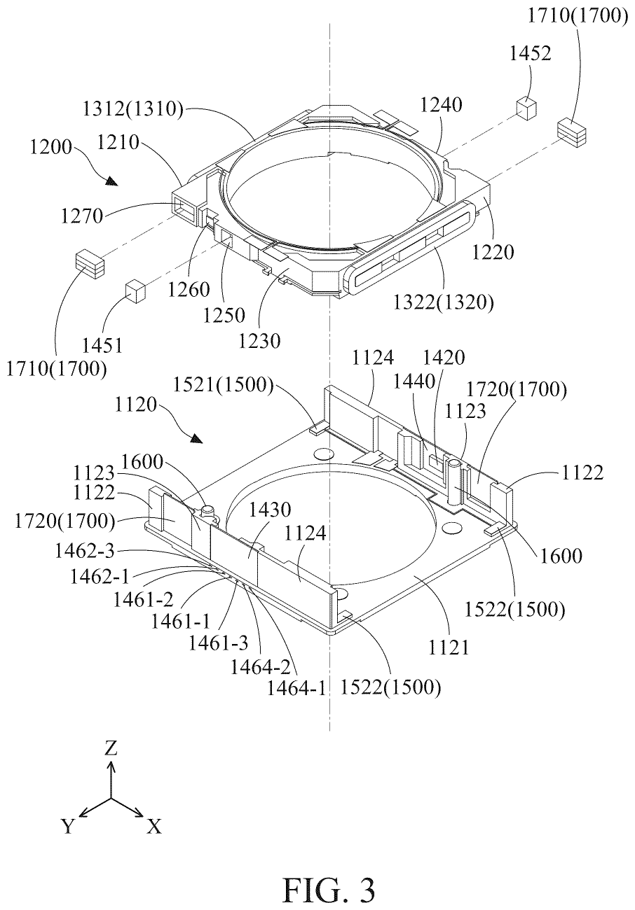

FIG. 3 shows an exploded view of the base 1120 and the movable portion 1200 according to some embodiments of the present disclosure. As shown in FIG. 3, the base 1120 includes a body 1121, two first retaining walls 1122, two second retaining walls 1123 and two third retaining walls 1124.

According to some embodiments of the present disclosure, the first retaining wall 1122, the second retaining wall 1123 and the third retaining wall 1124 are perpendicular to the body 1121. The first retaining wall 1122, the second retaining wall 1123, and the third retaining wall 1124 protrude from the body 1121 and extend upward (for example, toward the upper cover 1110 in FIG. 2) in a direction parallel to the optical axis O (FIG. 2).

According to some embodiments of the present disclosure, the movable portion 1200 includes a first side 1210, a second side 1220, a third side 1230, a fourth side 1240, two first grooves 1250, two second grooves 1260 and two third grooves 1270.

As shown in FIG. 3, the first side 1210 and the second side 1220 of the movable portion 1200 are two opposite sides. The third side 1230 and the fourth side 1240 of the movable portion 1200 are two opposite sides. The first side 1210 of the movable portion 1200 is located between the third side 1230 and the fourth side 1240. The second side 1220 of the movable portion 1200 is located between the third side 1230 and the fourth side 1240.

As shown in FIG. 3, the driving coil 1312 of the first driving portion 1310 is disposed on the first side 1210 of the movable portion 1200. The driving coil 1322 of the second driving portion 1320 is disposed on the second side 1220 of the movable portion 1200.

According to some embodiments of the present disclosure, the two first grooves 1250 are respectively located on the third side 1230 and the fourth side 1240 of the movable portion 1200. The two second grooves 1260 are respectively located on the third side 1230 and the fourth side 1240 of the movable portion 1200. The two third grooves 1270 are respectively located on the third side 1230 and the fourth side 1240 of the movable portion 1200.

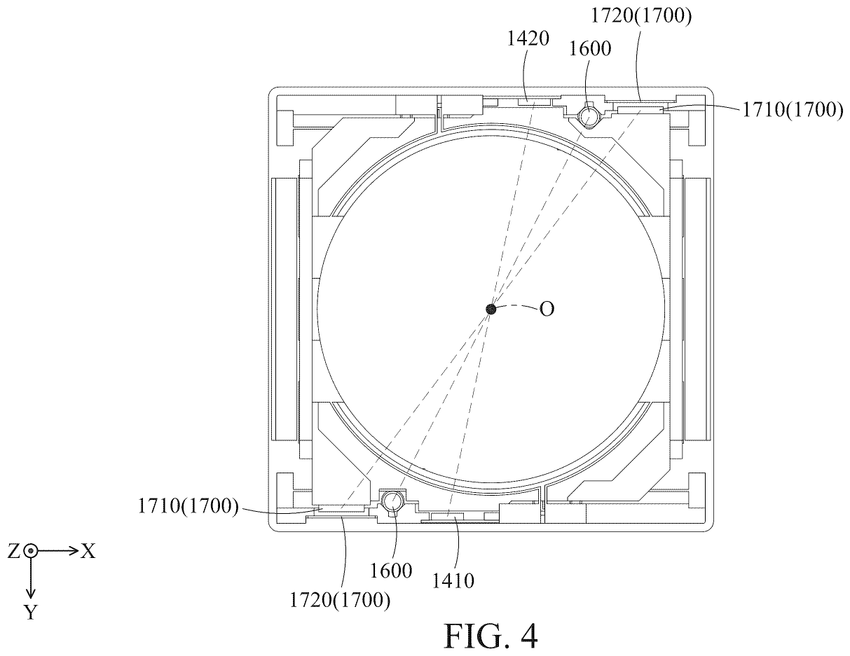

Although the first groove 1250, the second groove 1260 and the third groove 1270 located on the fourth side 1240 of the movable portion 1200 are not visible from the perspective of FIG. 3, it should be understood that the two first grooves 1250, the two second grooves 1260, and the two third grooves 1270 are each positioned diagonally on the movable portion 1200. The details of these features are more clearly shown in FIG. 4.

According to some embodiments of the present disclosure, the sensing magnet 1451 is disposed in the first groove 1250 on the third side 1230 of the movable portion 1200. The sensing magnet 1452 is disposed in the first groove 1250 on the fourth side 1240 of the movable portion 1200. The two guide elements 1600 respectively contact the second grooves 1260 on the third side 1230 and the fourth side 1240 of the movable portion 1200.

According to some embodiments of the present disclosure, two magnetic elements 1710 are respectively disposed in the third grooves 1270 on the third side 1230 and the fourth side 1240 of the movable portion 1200. As shown in FIG. 3, the second groove 1260 on the third side 1230 of the movable portion 1200 is located between the first groove 1250 and the third groove 1270. Although not shown in FIG. 3, the second groove 1260 on the fourth side 1240 of the movable portion 1200 is also located between the first groove 1250 and the third groove 1270 in the same manner.

According to some embodiments of the present disclosure, the magnetic plate 1720 of the magnetic component 1700 is disposed between the first retaining wall 1122 and the second retaining wall 1123. The guide element 1600 is disposed on the second retaining wall 1123. As shown in FIG. 3, the second integrated circuit 1420 is disposed on the second circuit member 1440, and the second circuit member 1440 is disposed between the second retaining wall 1123 and the third retaining wall 1124.

It is understood that although the first integrated circuit 1410 is not visible from the perspective of FIG. 3, it is also disposed on the first circuit member 1430 in the same manner as the second integrated circuit 1420. The first circuit member 1430 is positioned between the second retaining wall 1123 and the third retaining wall 1124 on the other side of the second circuit member 1440.

As shown in FIG. 3, one guide element 1600 is positioned between the magnetic plate 1720 of the magnetic component 1700 and the first circuit member 1430, and the other guide element 1600 is positioned between the magnetic plate 1720 of the magnetic component 1700 and the second circuit member 1440.

FIG. 4 shows a top view of the optical element driving mechanism 1000 according to some embodiments of the present disclosure, in which the upper cover 1110 is not shown for illustration purposes. As shown in FIG. 4, the two guide elements 1600 are disposed at diagonal positions of the optical element driving mechanism 1000. The two magnetic components 1700 are disposed at diagonal positions of the optical element driving mechanism 1000. The first integrated circuit 1410 and the second integrated circuit 1420 are disposed at diagonal positions of the optical element driving mechanism 1000.

As shown in FIG. 4, when viewed along the optical axis O, the shortest distance between the two magnetic components 1700 is greater than the shortest distance between the two guide elements 1600. When viewed along the optical axis O, the shortest distance between the two guide elements 1600 is greater than the shortest distance between the first integrated circuit 1410 and the second integrated circuit 1420. When viewed along the direction that is perpendicular to the optical axis O (e.g., Y axis), the first integrated circuit 1410 and the second integrated circuit 1420 do not overlap.

As shown in FIG. 4, the imaginary line between the two guide elements 1600 passes through the optical axis O of the optical element (not shown) when viewed along the optical axis O. When viewed along the optical axis O, the imaginary line between the two magnetic components 1700 passes through the optical axis O of the optical element. When viewed along the optical axis O, the imaginary line between the first integrated circuit 1410 and the second integrated circuit 1420 passes through the optical axis O of the optical element.

FIG. 5 shows a perspective view of a base 1120 and a connection component 1460 at least partially embedded in the base 1120 according to some embodiments of the present disclosure, where the base 1120 is shown in dashed line for illustration purposes. As shown in FIG. 5, the connection component 1460 is terminals that are embedded in the base 1120.

FIG. 6 shows a perspective view of a connection component 1460 according to some embodiments of the present disclosure. As shown in FIG. 6, the connection component 1460 includes a first connection element 1461, a second connection element 1462, a third connection element 1463 and a fourth connection element 1464.

As shown in FIG. 6, when viewed along the direction perpendicular to the optical axis O (for example, the X axis or the Y axis), the first connection element 1461 and the second connection element 1462 partially overlap. The third connection element 1463 is located on the periphery of the second connection element 1462, and the fourth connection element 1464 is located on the periphery of the first connection element 1461.

According to some embodiments of the present disclosure, the first connection element 1461 includes a first terminal 1461-1, a second terminal 1461-2 and a third terminal 1461-3. When viewed along the optical axis O (which is parallel to the Z-axis), the first terminal 1461-1 is located between the second terminal 1461-2 and the third terminal 1461-3.

According to some embodiments of the present disclosure, two ends of the first connection element 1461 are connected to the first circuit member 1430 and the second circuit member 1440 respectively. In detail, the first terminal 1461-1 includes a connecting portion 1461-11 and two extending portions 1461-12 and 1461-13. The extending portions 1461-12 and 1461-13 respectively extend from opposite ends of the connecting portion 1461-11.

According to some embodiments of the present disclosure, extending portion 1461-12 is connected to first circuit member 1430 (FIG. 3). The extending portion 1461-13 is connected to second circuit member 1440 (FIG. 3). When viewed along the direction perpendicular to the optical axis O, the extending portions 1461-12 and 1461-13 do not overlap with the connecting portion 1461-11.

That is to say, the connecting portion 1461-11 and the extending portions 1461-12 and 1461-13 have different positions on the Z-axis. In this way, the connecting portion 1461-11 can be exposed on the bottom surface of the base 1120 (FIG. 5), so that an external circuit (not shown) may be electrically connected to the connecting portion 1461-11.

According to some embodiments of the present disclosure, the second terminal 1461-2 is electrically connected to the first circuit member 1430 (FIG. 3). The two ends of the third terminal 1461-3 are electrically connected to the first circuit member 1430 (FIG. 3) and the second circuit member 1440 (FIG. 3) respectively.

In detail, the second terminal 1461-2 includes a connecting portion 1462-21 and an extending portion 1461-22. The connecting portion 1461-21 and the extending portion 1461-22 have different positions on the Z-axis. In this way, the connecting portion 1461-21 may be exposed on the bottom surface of the base 1120 (FIG. 5), so that an external circuit (not shown) may be electrically connected to the connecting portion 1461-21.

Furthermore, the extending portion 1461-22 of the second terminal 1461-2 and the third terminal 1461-3 are electrically connected through cross-wiring, e.g., directly with a jumper wire or via the wiring on the first circuit member 1430 (FIG. 3).

Similarly, the second connection element 1462 includes a first terminal 1462-1, a second terminal 1462-2 and a third terminal 1462-3. When viewed along the optical axis O (which is parallel to the Z-axis), the first terminal 1462-1 is positioned between the second terminal 1462-2 and the third terminal 1462-3.

According to some embodiments of the present disclosure, the first terminal 1462-1 includes a connecting portion 1462-11 and two extending portions 1462-12 and 1462-13. The extending portions 1462-12 and 1462-13 respectively extend from opposite ends of the connecting portion 1462-11.

According to some embodiments of the present disclosure, two ends of the second connection element 1462 are connected to the first circuit member 1430 and the second circuit member 1440 respectively. In detail, the extending portion 1462-12 is connected to first circuit member 1430 (FIG. 3). The extending portion 1462-13 is connected to second circuit member 1440 (FIG. 3).

According to some embodiments of the present disclosure, when viewed along the direction perpendicular to the optical axis O (for example, the X-axis or the Y-axis), the extending portions 1462-12, 1462-13 and the connecting portion 1462-11 do not overlap. That is to say, the connecting portion 1462-11 and the extending portions 1462-12 and 1462-13 have different positions along the Z-axis. In this way, the connecting portion 1462-11 may be exposed on the bottom surface of the base 1120 (FIG. 5), so that an external circuit (not shown) may be electrically connected to the connecting portion 1462-11.

According to some embodiments of the present disclosure, the second terminal 1462-2 is electrically connected to the second circuit member 1440 (FIG. 3). Two ends of the third terminal 1462-3 are electrically connected to the first circuit member 1430 (FIG. 3) and the second circuit member 1440 (FIG. 3) respectively.

In detail, the second terminal 1462-2 includes a connecting portion 1462-21 and an extending portion 1462-22. The connecting portion 1462-21 and the extending portion 1462-22 have different positions along the Z-axis. In this way, the connecting portion 1462-21 may be exposed on the bottom surface of the base 1120 (FIG. 5), so that an external circuit (not shown) may be electrically connected to the connecting portion 1462-21.

Furthermore, the extending portion 1462-22 of the second terminal 1462-2 and the third terminal 1462-3 are electrically connected through cross-wiring, e.g., directly with a jumper wire or via the wiring on the second circuit member 1440 (FIG. 3).

According to some embodiments of the present disclosure, the third connection element 1463 is electrically connected to the first driving portion 1310 (FIG. 2). In detail, the third connection element 1463 includes a first terminal 1463-1 and a second terminal 1463-2. Two ends of the first terminal 1463-1 and the second terminal 1463-2 are electrically connected to the second circuit member 1440 (FIG. 3) and the second elastic element 1521 (FIG. 3) respectively, to provide the output of the driving coil 1312 (FIG. 2) of the first driving portion 1310.

Similarly, the fourth connection element 1464 is electrically connected to the second driving portion 1320. In detail, the fourth connection element 1464 includes a first terminal 1464-1 and a second terminal 1464-2. Two ends of the first terminal 1464-1 and the second terminal 1464-2 are electrically connected to the first circuit member 1430 (FIG. 3) and the second elastic element 1522 (FIG. 3) respectively, to provide the output of the driving coil 1322 (FIG. 2) of the second driving portion 1320.

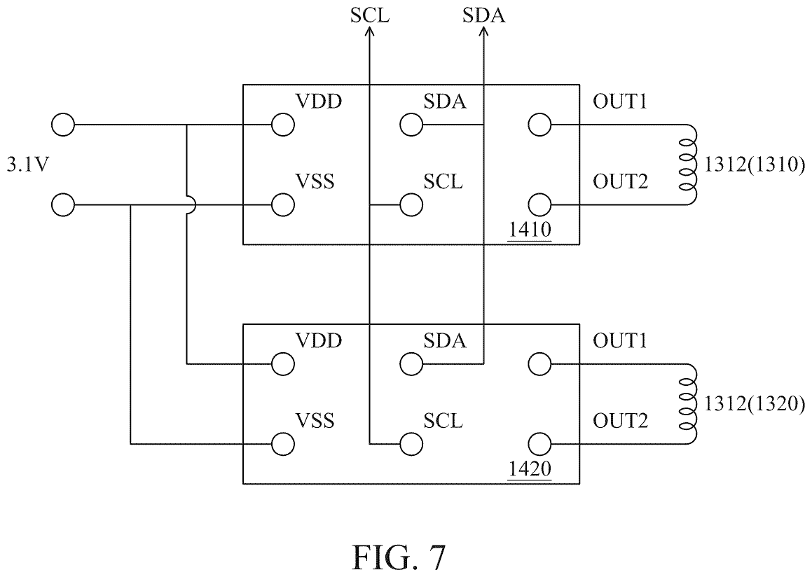

FIG. 7 is a circuit schematic diagram of the optical element driving mechanism 1000 according to some embodiments of the present disclosure. Please refer to FIG. 6 and FIG. 7 together. The first terminal 1461-1 of the first connection element 1461 functions as the VDD pins, and the second terminal 1461-2 and the third terminal 1461-3 function as the VSS pins, to provide power supply functionality for the first integrated circuit 1410 and the second integrated circuit 1420.

According to some embodiments of the present disclosure, the first terminal 1462-1 of the second connection element 1462 functions as the SCL pins, and the second terminal 1462-2 and the third terminal 1462-3 function as the SDA pins, to enable the I²C signal transmission functionality of the first integrated circuit 1410 and the second integrated circuit 1420.

According to some embodiments of the present disclosure, the first terminal 1463-1 and the second terminal 1463-2 of the third connection element 1463 function as OUT1 and OUT2 pins, respectively, and are responsible for outputting driving signals to the driving coil 1312 of the first driving portion 1310.

According to some embodiments of the present disclosure, the first terminal 1464-1 and the second terminal 1464-2 of the fourth connection element 1464 function as OUT1 and OUT2 pins, respectively, and are responsible for outputting driving signals to the driving coil 1322 of the second driving unit 1320.

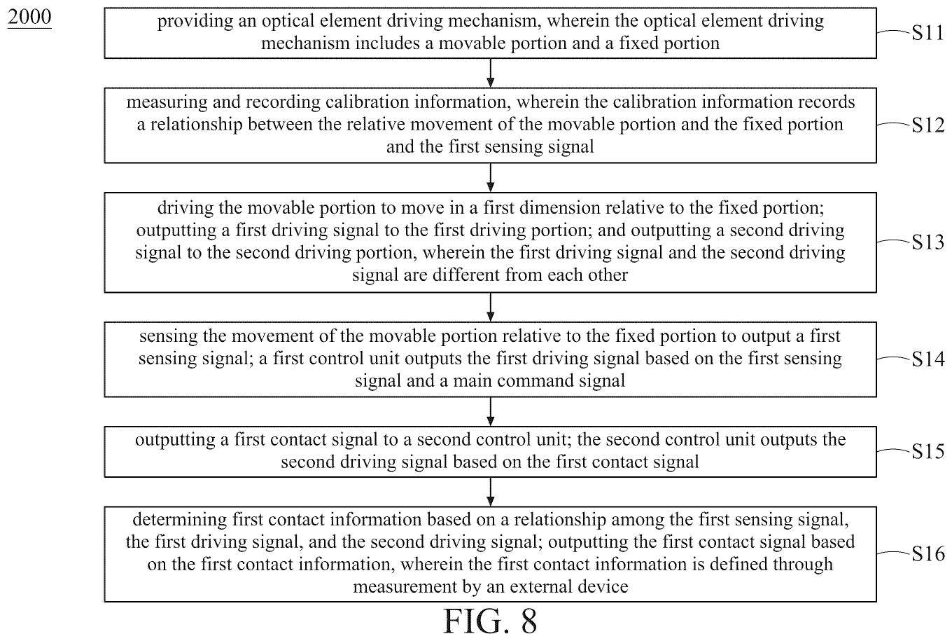

FIG. 8 is a flow chart of the first embodiment of the method for controlling the optical element driving mechanism 1000, referred to here as the control method 2000. In this embodiment, of the first integrated circuit 1410 (FIG. 2) or the second integrated circuit 1420 (FIG. 2), only one has a sensing function.

Specifically, the element with the sensing function is responsible for controlling the operation of the other element. The element with the sensing function acts as the master unit, issuing control commands, while the other element performs driving operations based on the received commands. In this way, interference between the driving signal and the sensing signal may be avoided, achieving better driving performance.

As shown in FIG. 8, the control method 2000 includes steps S11, S12, S13, S14, S15, and S16. Step S11 includes providing the optical element driving mechanism 1000. Step S12 includes measuring and recording a calibration information. The calibration information records the relationship between the relative movement of the movable portion 1200 and the fixed portion 1100, and the first sensing signal output by the first sensing element (the sensing integrated circuit in the first integrated circuit 1410). An external device performs the aforementioned measuring and recording of the calibration information, and the external device is removed from the optical element driving mechanism 1000 after the calibration is completed.

It should be understood that the primary purpose of the calibration information is to compensate for differences in driving signals when there is only one sensing element (the first sensing element in this embodiment) through prior measurement and recording. This allows for accurate adjustments during subsequent calibration. For example, the calibration information records the data or parameters of the driving force differences generated by the first driving portion 1310 and the second driving portion 1320 under identical current conditions (due to the physical characteristics of the driving mechanism or other factors). These records are used to correct the driving signals of both portions during subsequent driving operations, thereby achieving precise control.

Step S13 includes: driving the movable portion 1200 relative to the fixed portion 1100 in the first dimension; outputting a first driving signal to the first driving portion 1310; and outputting a second driving signal to the second driving portion 1320, wherein the first driving signal and the second driving signal are different from each other.

As mentioned above, the first integrated circuit 1410 and the second integrated circuit 1420 of the present disclosure may integrate both sensing and control functions, depending on the requirements. Accordingly, it should be understood that the first sensing element and the first control unit mentioned below refer to the sensing integrated circuit and the control integrated circuit packaged within the first integrated circuit 1410, while the second control unit mentioned below refers to the control integrated circuit packaged within the second integrated circuit 1420.

As shown in FIG. 8, step S14 includes sensing the movement of the movable portion 1200 relative to the fixed portion 1100 to output a first sensing signal, and the first control unit (the control integrated circuit in the first integrated circuit 1410) outputs the first driving signal based on the first sensing signal and the main command signal, wherein the main command signal is output by a central unit, and the first sensing signal is output by the first sensing element. It should be understood that the aforementioned central unit (not shown) may be a central unit in an external circuit to which the optical element driving mechanism 1000 is electrically connected (for example, a central processing unit (CPU) of a mobile phone).

As shown in FIG. 8, step S15 includes outputting a first contact signal to the second control unit (the control integrated circuit in the second integrated circuit 1420) of the control component 1400, and the second control unit outputs the second driving signal based on the first contact signal, wherein the first contact signal is output by the first control unit. That is to say, in this step, the first control unit serves as the master unit responsible for issuing control commands, while the second control unit performs driving operations based on the received commands.

As shown in FIG. 8, step S16 includes: determining a first contact information based on the relationship among the first sensing signal, the first driving signal, and the second driving signal; and outputting the first contact signal based on the first contact information, wherein the first contact information is defined through measurement by an external device.

The control component 1400 outputs the first contact information based on the motion state of the optical element driving mechanism 1000 in step S15 and the pre-measured calibration information. Subsequently, the first control unit outputs the first contact signal based on the first contact information to correct the differences between the first driving signal and the second driving signal (caused by the physical characteristics of the driving mechanism or other factors), thereby balancing the driving forces they generate.

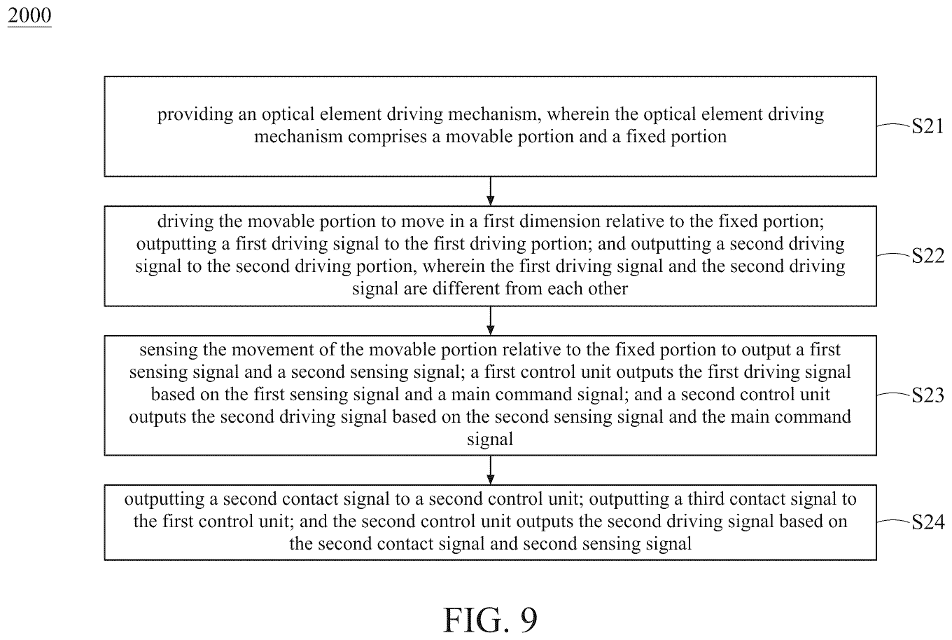

FIG. 9 is a flow chart of the second embodiment of the control method 2000 for the optical element driving mechanism 1000. In this embodiment, both the first integrated circuit 1410 (FIG. 2) and the second integrated circuit 1420 (FIG. 2) have sensing functions, enabling the optical element driving mechanism 1000 to acquire data simultaneously from two different sensing points (the first integrated circuit 1410 and the second integrated circuit 1420) to enhance motion accuracy and stability.

As described above, the dual-driving and dual-sensing integrated circuit design ensures that the two driving components may independently receive and process driving signals, achieving more flexible control. Compared to the previous embodiment, the master-master control mode further enhances system synchronization, allowing the two master control units to coordinate with each other without relying on subordinate control units, thereby achieving highly synchronized and precise motion control.

As shown in FIG. 9, the second embodiment of the control method 2000 includes steps S21, S22, S23, and S24. Step S21 includes providing the optical element driving mechanism 1000. Step S22 includes: driving the movable portion 1200 to move in the first dimension relative to the fixed portion 1100; outputting a first driving signal to the first driving portion; and outputting a second driving signal to the second driving portion, wherein the first driving signal and the second driving signal are different from each other.

As shown in FIG. 9, step S23 includes sensing the movement of the movable portion 1200 relative to the fixed portion 1100 to output a first sensing signal and a second sensing signal. The first control unit outputs a first driving signal based on the first sensing signal and the main command signal, while the second control unit outputs a second driving signal based on the second sensing signal and the main command signal. The main command signal is output by a central unit, the first sensing signal is output by the first sensing element, and the second sensing signal is output by the second sensing element (the sensing integrated circuit in the second integrated circuit 1420).

As shown in FIG. 9, step S24 includes: outputting a second contact signal to the second control unit, outputting a third contact signal to the first control unit, and the second control unit outputting a second driving signal based on the second contact signal and the second sensing signal. The second contact signal is output by the first control unit, and the third contact signal is output by the second control unit. In other words, the two master control units may coordinate with each other, thereby achieving highly synchronized and precise motion control.

It should be understood that the second embodiment of the control method 2000 further includes second contact information determined based on the relationship between the first sensing signal and the second sensing signal, and third contact information determined based on the relationship between the second sensing signal and the first sensing signal, wherein the second contact information is identical to the third contact information.

In other words, both the second contact information and the third contact information are pre-measured and defined by an external device, corresponding respectively to the output value of the first sensing signal relative to the second sensing signal and the output value of the second sensing signal relative to the first sensing signal when the movable portion 1200 is at different positions. Through this process, coordination between the two master control units is achieved. Consequently, the second contact information is identical to the third contact information.

However, in a variant embodiment of the second embodiment of the control method 2000 for the optical element driving mechanism 1000, the optical element driving mechanism 1000 further includes a third sensing element (not shown), which may be disposed, for example, on the first side 1210 of the movable portion 1200 (FIG. 3).

In this variant embodiment, the third sensing signal output by the third sensing element determines the third contact information. Consequently, in this embodiment, the second contact information and the third contact information are different. With this configuration, the optical element driving mechanism 1000 may detect whether the movable portion 1200 is tilted through the first sensing element, the second sensing element, and the third sensing element, thereby achieving more precise sensing.

To sum up, the optical element driving mechanism of the present invention has two integrated circuits (the first integrated circuit and the second integrated circuit). Compared with an optical element driving mechanism with only one integrated circuit, the optical element driving mechanism of the present invention provides greater driving force to the driving components.

The present invention is characterized by its unique method for controlling the optical element driving mechanism, which includes two embodiments. The first embodiment adopts a master-slave control mode, where the integrated circuit with sensing functionality serves as the master control unit, responsible for issuing control commands, while the other component performs driving operations based on the received commands. This configuration effectively avoids interference between the driving signals and sensing signals, thereby achieving improved driving performance. The second embodiment adopts a master-master control mode, utilizing a dual-driving and dual-sensing integrated circuit design to ensure that the two driving components can independently receive and process driving signals. This provides greater flexibility in control capabilities and higher system stability.

Although the embodiments of the present disclosure and their advantages have been disclosed above, it should be understood that those skilled in the art may make modifications, substitutions, and refinements without departing from the spirit and scope of the present disclosure. Furthermore, the scope of protection of the present disclosure is not limited to the specific embodiments described in the specification, including processes, machines, manufacture, compositions of matter, devices, methods, and steps. Those skilled in the art may understand from the disclosures herein any processes, machines, manufacture, compositions of matter, devices, methods, and steps developed in the future or presently that perform substantially the same function or achieve substantially the same result as those described in the embodiments, and such are intended to fall within the scope of the present disclosure. Accordingly, the scope of protection of the present disclosure includes the aforementioned processes, machines, manufacture, compositions of matter, devices, methods, and steps. In addition, each claim constitutes an individual embodiment, and the scope of protection of the present disclosure also includes combinations of various claims and embodiments.

What is claimed is:

1. A method for controlling an optical element driving mechanism, comprising:
providing an optical element driving mechanism, wherein the optical element driving mechanism comprises a movable portion and a fixed portion; and
driving the movable portion to move in a first dimension relative to the fixed portion.

2. The method for controlling the optical element driving mechanism as claimed in claim 1, wherein the optical element driving mechanism further comprises a first driving portion and a second driving portion, and the method further comprises:
outputting a first driving signal to the first driving portion; and
outputting a second driving signal to the second driving portion.

3. The method for controlling the optical element driving mechanism as claimed in claim 2, wherein the first driving signal and the second driving signal are different from each other.

4. The method for controlling the optical element driving mechanism as claimed in claim 2, further comprising:
sensing the movement of the movable portion relative to the fixed portion to output a first sensing signal.

5. The method for controlling the optical element driving mechanism as claimed in claim 4, further comprising:
a first control unit outputs the first driving signal based on the first sensing signal and a main command signal.

6. The method for controlling the optical element driving mechanism as claimed in claim 5, further comprising:
outputting a first contact signal to a second control unit.

7. The method for controlling the optical element driving mechanism as claimed in claim 6, further comprising:
the second control unit outputs the second driving signal based on the first contact signal.

8. The method for controlling the optical element driving mechanism as claimed in claim 7, further comprising:
measuring and recording calibration information, wherein the calibration information records a relationship between the relative movement of the movable portion and the fixed portion and the first sensing signal.

9. The method for controlling the optical element driving mechanism as claimed in claim 8, further comprising:
determining first contact information based on a relationship among the first sensing signal, the first driving signal and the second driving signal.

10. The method for controlling the optical element driving mechanism as claimed in claim 9, further comprising:
outputting the first contact signal based on the first contact information.

11. The method for controlling the optical element driving mechanism as claimed in claim 10, further comprising:
sensing the movement of the movable portion relative to the fixed portion to output a second sensing signal.

12. The method for controlling the optical element driving mechanism as claimed in claim 11, further comprising:
a second control unit outputs the second driving signal based on the second sensing signal and the main command signal.

13. The method for controlling the optical element driving mechanism as claimed in claim 12, further comprising:
outputting a second contact signal to the second control unit;
outputting a third contact signal to the first control unit.

14. The method for controlling the optical element driving mechanism as claimed in claim 13, further comprising:
the second control unit outputs the second driving signal based on the second contact signal and the second sensing signal.

15. The method for controlling the optical element driving mechanism as claimed in claim 14, further comprising:
determining second contact information based on a relationship between the first sensing signal and the second sensing signal.

16. The method for controlling the optical element driving mechanism as claimed in claim 15, further comprising:
determining third contact information based on a relationship between the second sensing signal and the first sensing signal, wherein the second contact information is the same as the third contact information.

17. The method for controlling the optical element driving mechanism as claimed in claim 15, further comprising:
determining third contact information based on a third sensing signal, wherein the second contact information is different from the third contact information.
